(19) United States
(12) Patent Application Publication
(10) Pub. No.: US 2011/0077106 A1
(43) Pub. Date: Mar. 31, 2011

(54) Golf Ball Having An Aerodynamic Coating

(75) Inventor: Derek Fitchett, Portland, OR (US)

(73) Assignee: Nike, Inc., Beaverton, OR (US)

(21) Appl. No.: 12/569,955

(22) Filed: Sep. 30, 2009

(51) Int. Cl. A63B 37/12; B05D 1/12

(52) U.S. Cl. 473/385; 473/378; 427/180; 427/189

(57) ABSTRACT

A golf ball includes a golf ball body; and a coating applied to the outer surface of the golf ball body. The coating comprises a resin and a plurality of particles, wherein the particles have an average size of 400 nm to 40 microns. The particles are contained within the resin or adhered to and/or embedded in a resin layer.

### FIELD OF THE INVENTION

The present invention relates to golf balls. Particular example aspects of this invention relate to golf balls having a coating that improves the aerodynamic performance of the ball.

### BACKGROUND

Golf is enjoyed by a wide variety of players—players of different genders and dramatically different ages and/or skill levels. Golf is somewhat unique in the sporting world in that such diverse collections of players can play together in golf events, even in direct competition with one another (e.g., using handicapped scoring, different tee boxes, in team formats, etc.), and still enjoy the golf outing or competition. These factors, together with the increased availability of golf programming on television (e.g., golf tournaments, golf news, golf history, and/or other golf programming) and the rise of well known golf superstars, at least in part, have increased golf's popularity in recent years, both in the United States and across the world.

Golfers at all skill levels seek to improve their performance, lower their golf scores, and reach that next performance “level.” Manufacturers of all types of golf equipment have responded to these demands, and in recent years, the industry has witnessed dramatic changes and improvements in golf equipment. For example, a wide range of different golf ball models now are available, with balls designed to complement specific swing speeds and/or other player characteristics or preferences, e.g., with some balls designed to fly farther and/or straighter; some designed to provide higher or flatter trajectories; some designed to provide more spin, control, and/or feel (particularly around the greens); some designed for faster or slower swing speeds; etc. A host of swing and/or teaching aids also are available on the market that promise to help lower one's golf scores.

Being the sole instrument that sets a golf ball in motion during play, golf clubs also have been the subject of much technological research and advancement in recent years. For example, the market has seen dramatic changes and improvements in putter designs, golf club head designs, shafts, and grips in recent years. Additionally, other technological advancements have been made in an effort to better match the various elements and/or characteristics of the golf club and characteristics of a golf ball to a particular user's swing features or characteristics (e.g., club fitting technology, ball launch angle measurement technology, ball spin rate measurement technology, ball fitting technology, etc.).

Modern golf balls generally comprise either a one-piece construction or several layers including an outer cover surrounding a core. Typically, one or more layers of paint and/or other coatings are applied to the outer surface of the golf ball. For example, in one typical design, the outer surface of the golf ball is first painted with at least one clear or pigmented basecoat primer followed by at least one application of a clear coating or topcoat. The clear coating may serve a variety of functions, such as protecting the cover material (e.g., improving abrasion resistance or durability), improving aerodynamics of ball flight, preventing yellowing, and/or improving aesthetics of the ball.

One common coating utilizes a solvent borne two-component polyurethane, which is applied to the exterior of a golf ball. The coating may be applied, for example, by using compressed air to deliver and spray the coating materials.

Dimples were added to golf balls to improve the aerodynamics over smooth balls. Variations of the dimples have been introduced over the years relating to their size, shape, depth, and pattern. Other concepts have included the inclusion of small dimples within dimples to provide different aerodynamic performance. Such small dimples would often be filled up during application of a top coat to the outer surface of the ball thus destroying the intended effect of the balls.

While the industry has witnessed dramatic changes and improvements to golf equipment in recent years, some players continue to look for increased distance on their golf shots, particularly on their drives or long iron shots, and/or improved spin or control of their shots, particularly around the greens. Accordingly, there is room in the art for further advances in golf technology.

### SUMMARY

The following presents a general summary of aspects of the disclosure in order to provide a basic understanding of the disclosure and various aspects of it. This summary is not intended to limit the scope of the disclosure in any way, but it simply provides a general overview and context for the more detailed description that follows.

Aspects of this invention are directed to a coating comprising a resin and particles applied to a surface of a golf ball, as well as to golf balls including such coatings.

Other aspects of this invention are directed to methods for applying a coating comprising a resin and particles to a surface of a golf ball.

### BRIEF DESCRIPTION OF THE DRAWINGS

A more complete understanding of the present invention and certain advantages thereof may be acquired by referring to the following detailed description in consideration with the accompanying drawings, in which:

FIG. 1 schematically illustrates a golf ball having dimples.

FIGS. 2 and 2A schematically illustrate a cross-sectional view of a golf ball in accordance with FIG. 1 having a coating thereon.

FIG. 3 schematically illustrates a cross-sectional view of a portion of a golf ball having a cover layer and coating in accordance with FIG. 1 having particles contained within a resin.

FIG. 4 schematically illustrates a cross-sectional view of a portion of a golf ball having a cover layer and coating in accordance with FIG. 1 having particles applied onto the surface of a resin.

FIG. 5 depicts test results for Wet Sand Abrasion.

FIG. 6 depicts test results for Wedge Abrasion.

FIG. 7 depicts spin results of golf balls with a driver.

FIG. 8 depicts spin results of golf balls with a 6 iron.

FIG. 9 depicts spin results of golf balls with a wedge.

The reader is advised that the various parts shown in these drawings are not necessarily drawn to scale.

### DETAILED DESCRIPTION

In the following description of various example structures, reference is made to the accompanying drawings, which form a part hereof, and in which are shown by way of illustration various example golf ball structures. Additionally, it is to be understood that other specific arrangements of parts and structures may be utilized and structural and functional modifications may be made without departing from the scope of the present invention. Also, while terms such as “top,” “bottom,” “front,” “back,” “rear,” “side,” “underside,” “overhead,” and the like may be used in this specification to describe various example features and elements of the invention, these terms are used herein as a matter of convenience, e.g., based on the example orientations shown in the figures and/or the orientations in typical use. Nothing in this specification should be construed as requiring a specific three dimensional or spatial orientation of structures.

### A. General Description of Golf Balls and Manufacturing Systems and Methods

Golf balls may be of varied construction, e.g., one-piece balls, two-piece balls, three-piece balls (including wound balls), four-piece balls, five-piece balls, etc. The difference in play characteristics resulting from these different types of constructions can be quite significant. Generally, golf balls may be classified as solid or wound balls. Solid balls that have a two-piece construction, typically a cross-linked rubber core, e.g., polybutadiene cross-linked with zinc diacrylate and/or similar cross-linking agents, encased by a blended cover, e.g., ionomer resins, are popular with many average recreational golfers. The combination of the core and cover materials provide a relatively “hard” ball that is virtually indestructible by golfers and one that imparts a high initial velocity to the ball, resulting in improved distance. Because the materials from which the ball is formed are very rigid, two-piece balls tend to have a hard “feel” when struck with a club. Likewise, due to their hardness, these balls have a relatively low spin rate, which also helps provide greater distance.

Wound balls are generally constructed from a liquid or solid center surrounded by tensioned elastomeric material and covered with a durable cover material, e.g., ionomer resin, or a softer cover material, e.g., balata or polyurethane. Wound balls are generally thought of as performance golf balls and have good resiliency, desirable spin characteristics, and good “feel” when struck by a golf club. However, wound balls are generally difficult to manufacture as compared to solid golf balls.

More recently, three- and four-piece balls have gained popularity, both as balls for average recreational golfers as well as performance balls for professional and other elite level players. Such balls typically include a core (optionally a multi-part core, such as an inner core and an outer core), one or more mantle or intermediate layers (also called “inner cover” layers), and an outer cover layer.

A variety of golf balls have been designed to provide particular playing characteristics. These characteristics generally include the initial velocity and spin of the golf ball, which can be optimized for various types of players. For instance, certain players prefer a ball that has a high spin rate in order to control and stop the golf ball around the greens. Other players prefer a ball that has a low spin rate and high resiliency to maximize distance. Generally, a golf ball having a hard core and a soft cover will have a high spin rate. Conversely, a golf ball having a hard cover and a soft core will have a low spin rate. Golf balls having a hard core and a hard cover generally have very high resiliency for distance, but they may “feel” hard and be difficult to control around the greens.

The carry distance of some conventional two-piece balls has been improved by altering the typical single layer core and single cover layer construction to provide a multi-layer ball, e.g., a dual cover layer, dual core layer, and/or a ball having an intermediate layer disposed between the cover and the core. Three- and four-piece balls are now commonly found and commercially available. Aspects of this invention may be applied to all types of ball constructions, including the wound, solid, and/or multi-layer ball constructions described above.

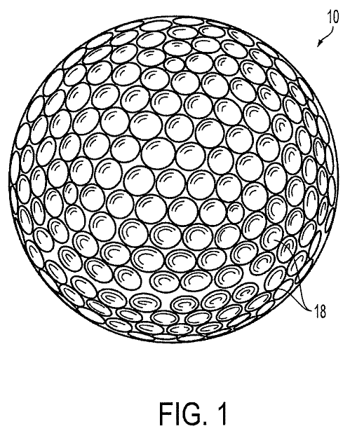

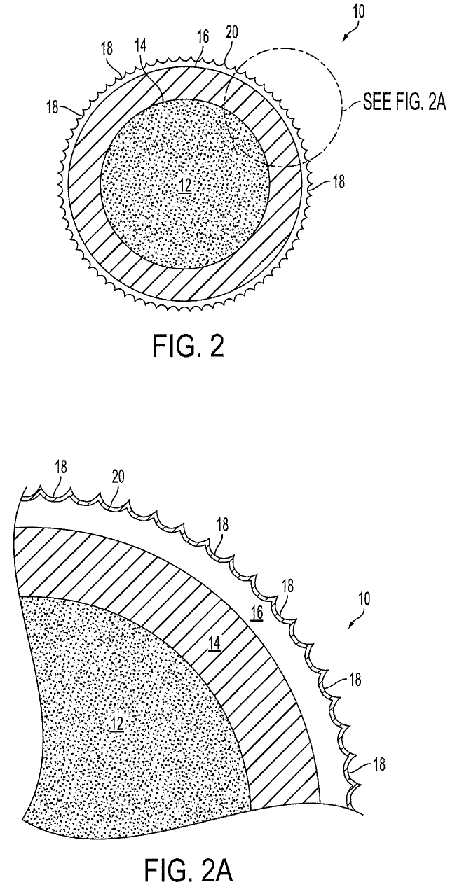

FIG. 1 shows an example of a golf ball 10 that includes a plurality of dimples 18 formed on its outer surface. FIGS. 2 and 2A show an example of a golf ball 10, which has a core 12, an intermediate layer 14, a cover 16 having a plurality of dimples 18 formed therein, and a coating 20 applied over the exterior surface of the golf ball 10. The golf ball 10 alternatively may be only one piece such that the core 12 represents the entirety of the golf ball 10, and the plurality of dimples are formed on the core 12. The ball 10 also may have any other desired construction, including conventional constructions and the various example constructions described herein. The thickness of the coating 20 typically is significantly less than that of the cover 16 or the intermediate layer 14, and by way of example may range from about 8 to about 50 μm. The coating 20 should be substantially uniformly applied to the exterior of the ball (e.g., a substantially uniform thickness) and should have a minimal effect on the depth and volume of the dimples 18. An optional primer or basecoat may be applied to the exterior surface of the cover 16 of the golf ball 10 prior to application of the coating layer 20.

### The Center

A golf ball may be formed, for example, with a center having a low compression, but still exhibit a finished ball COR and initial velocity approaching that of conventional two-piece distance balls. The center may have, for example, a compression of about 60 or less. The finished balls made with such centers have a COR, measured at an inbound speed of 125 ft./s., of about 0.795 to about 0.815. “COR” refers to Coefficient of Restitution, which is obtained by dividing a ball's rebound velocity by its initial (i.e., incoming) velocity. This test is performed by firing the samples out of an air cannon at a vertical steel plate over a range of test velocities (e.g., from 75 to 150 ft/s). A golf ball having a high COR dissipates a smaller fraction of its total energy when colliding with the plate and rebounding therefrom than does a ball with a lower COR.

The terms “points” and “compression points” refer to the compression scale or the compression scale based on the ATTI Engineering Compression Tester. This scale, which is well known to persons skilled in the art, is used in determining the relative compression of a center or ball.

The center may have, for example, a Shore C hardness of about 40 to about 80. The center may have a diameter of about 0.75 inches to about 1.68 inches. The base composition for forming the center may include, for example, polybutadiene and about 20 to 50 parts of a metal salt diacrylate, dimethacrylate, or monomethacrylate. If desired, the polybutadiene can also be mixed with other elastomers known in the art, such as natural rubber, styrene butadiene, and/or isoprene, in order to further modify the properties of the center. When a mixture of elastomers is used, the amounts of other constituents in the center composition are usually based on 100 parts by weight of the total elastomer mixture. In other examples, the center (or core) may be made from resin materials, such as HPF resins (optionally with barium sulfate included therein), which are commercially available from E.I. DuPont de Nemours and Company of Wilmington, Del.

Metal salt diacrylates, dimethacrylates, and monomethacrylates include without limitation those wherein the metal is magnesium, calcium, zinc, aluminum, sodium, lithium or nickel. Zinc diacrylate, for example, provides golf balls with a high initial velocity in the United States Golf Association (“USGA”) test.

Free radical initiators often are used to promote cross-linking of the metal salt diacrylate, dimethacrylate, or monomethacrylate and the polybutadiene. Suitable free radical initiators include, but are not limited to peroxide compounds, such as dicumyl peroxide; 1,1-di(t-butylperoxy) 3,3,5-trimethyl cyclohexane; bis(t-butylperoxy) diisopropylbenzene; 2,5-dimethyl-2,5 di(t-butylperoxy) hexane; or di-t-butyl peroxide; and mixtures thereof. The initiator(s) at 100 percent activity may be added in an amount ranging from about 0.05 to about 2.5 pph based upon 100 parts of butadiene, or butadiene mixed with one or more other elastomers. Often the amount of initiator added ranges from about 0.15 to about 2 pph, and more often from about 0.25 to about 1.5 pph. The golf ball centers may incorporate 5 to 50 pph of zinc oxide (ZnO) in a zinc diacrylate-peroxide cure system that cross-links polybutadiene during the core molding process.

The center compositions may also include fillers, added to the elastomeric (or other) composition to adjust the density and/or specific gravity of the center. Non-limiting examples of fillers include zinc oxide, barium sulfate, and regrind, e.g., recycled core molding matrix ground to about 30 mesh particle size. The amount and type of filler utilized is governed by the amount and weight of other ingredients in the composition, bearing in mind a maximum golf ball weight of 1.620 oz has been established by the USGA. Fillers usually range in specific gravity from about 2.0 to about 5.6. The amount of filler in the center may be lower such that the specific gravity of the center is decreased.

The specific gravity of the center may range, for example, from about 0.8 to about 1.3, depending upon such factors as the size of the center, cover, intermediate layer and finished ball, as well as the specific gravity of the cover and intermediate layer. Other components such as accelerators, e.g., tetra methylthiuram, processing aids, processing oils, plasticizers, dyes and pigments, antioxidants, as well as other additives well known to the skilled artisan may also be used in amounts sufficient to achieve the purpose for which they are typically used.

### Intermediate Layer(s)

The golf ball also may have one or more intermediate layers formed, for example, from dynamically vulcanized thermoplastic elastomers, functionalized styrene-butadiene elastomers, thermoplastic rubbers, polybutadiene rubbers, natural rubbers, thermoset elastomers, thermoplastic urethanes, metallocene polymers, thermoset urethanes, ionomer resins, or blends thereof. For example, an intermediate layer may include a thermoplastic or thermoset polyurethane. Non-limiting of commercially available dynamically vulcanized thermoplastic elastomers include SANTOPRENE®, SARLINK®, VYRAM®, DYTRON®, and VISTAFLEX®. SANTOPRENE® is a dynamically vulcanized PP/EPDM. Examples of functionalized styrene-butadiene elastomers, i.e., styrene-butadiene elastomers with functional groups such as maleic anhydride or sulfonic acid, include KRATON FG-1901x and FG-1921x, which are available from the Shell Corporation of Houston, Tex.

Examples of suitable thermoplastic polyurethanes include ESTANE® 58133, ESTANE® 58134 and ESTANE® 58144, which are commercially available from the B. F. Goodrich Company of Cleveland, Ohio.

Examples of metallocene polymers, i.e., polymers formed with a metallocene catalyst, include those commercially available from Sentinel Products of Hyannis, Mass. Suitable thermoplastic polyesters include polybutylene terephthalate. Thermoplastic ionomer resins may be obtained by providing a cross metallic bond to polymers of monoolefin with at least one member selected from the group consisting of unsaturated mono- or di-carboxylic acids having 3 to 12 carbon atoms and esters thereof (the polymer contains 1 to 50 percent by weight of the unsaturated mono- or di-carboxylic acid and/or ester thereof). More particularly, low modulus ionomers such as acid-containing ethylene copolymer ionomers, include E/X/Y copolymers where E is ethylene, X is a softening comonomer such as acrylate or methacrylate. Non-limiting examples of ionomer resins include SURLYN® and IOTEK®, which are commercially available from DuPont and Exxon, respectively.

Alternatively, the intermediate layer(s) may be a blend of a first and a second component wherein the first component is a dynamically vulcanized thermoplastic elastomer, a functionalized styrene-butadiene elastomer, a thermoplastic or thermoset polyurethane or a metallocene polymer and the second component is a material such as a thermoplastic or thermoset polyurethane, a thermoplastic polyetherester or polyetheramide, a thermoplastic ionomer resin, a thermoplastic polyester, another dynamically vulcanized elastomer, another a functionalized styrene-butadiene elastomer, another a metallocene polymer or blends thereof. At least one of the first and second components may include a thermoplastic or thermoset polyurethane.

One or more intermediate layers also may be formed from a blend containing an ethylene methacrylic/acrylic acid copolymer. Non-limiting examples of acid-containing ethylene copolymers include ethylene/acrylic acid; ethylene/methacrylic acid; ethylene/acrylic acid/n- or isobutyl acrylate; ethylene/methacrylic acid/n- or iso-butyl acrylate; ethylene/acrylic acid/methyl acrylate; ethylene/methacrylic acid/methyl acrylate; ethylene/acrylic acid/iso-bornyl acrylate or methacrylate and ethylene/methacrylic acid/isobornyl acrylate or methacrylate. Examples of commercially available ethylene methacrylic/acrylic acid copolymers include NUCREL® polymers, available from DuPont.

Alternatively, the intermediate layer(s) may be formed from a blend which includes an ethylene methacrylic/acrylic acid copolymer and a second component which includes a thermoplastic material. Suitable thermoplastic materials for use in the intermediate blend include, but are not limited to, polyesterester block copolymers, polyetherester block copolymers, polyetheramide block copolymers, ionomer resins, dynamically vulcanized thermoplastic elastomers, styrene-butadiene elastomers with functional groups such as maleic anhydride or sulfonic acid attached, thermoplastic polyurethanes, thermoplastic polyesters, metallocene polymers, and/or blends thereof.

An intermediate layer often has a specific gravity of about 0.8 or more. In some examples the intermediate layer has a specific gravity greater than 1.0, e.g., ranging from about 1.02 to about 1.3. Specific gravity of the intermediate layer may be adjusted, for example, by adding a filler such as barium sulfate, zinc oxide, titanium dioxide and combinations thereof.

The intermediate layer blend may have a flexural modulus of less than about 10,000 psi, often from about 5,000 to about 8,000 psi. The intermediate layers often have a Shore D hardness of about 35 to 70. The intermediate layer and core construction together may have a compression of less than about 65, often from about 50 to about 65. Usually, the intermediate layer has a thickness from about 0.020 inches to about 0.2 inches. The golf balls may include a single intermediate layer or a plurality of intermediate layers. In the case where a ball includes a plurality of intermediate layers, a first intermediate layer outside the core may include, for example, a thermoplastic material or a rubber material (synthetic or natural) having a hardness greater than that of the core. A second intermediate layer may be disposed around the first intermediate layer and may have a greater hardness than that of the first intermediate layer. The second intermediate layer may be formed of materials such as polyether or polyester thermoplastic urethanes, thermoset urethanes, and ionomers such as acid-containing ethylene copolymer ionomers.

In addition, if desired, a third intermediate layer (or even more layers) may be disposed in between the first and second intermediate layers. The third intermediate layer may be formed of the variety of materials as discussed above. For example, the third intermediate layer may have a hardness greater than that of the first intermediate layer.

### The Cover Layer

A golf ball also typically has a cover layer that includes one or more layers of a thermoplastic or thermosetting material. A variety of materials may be used such as ionomer resins, thermoplastic polyurethanes, balata and blends thereof.

The cover may be formed of a composition including very low modulus ionomers (VLMIs). As used herein, the term “very low modulus ionomers,” or the acronym “VLMIs,” are those ionomer resins further including a softening comonomer X, commonly a (meth)acrylate ester, present from about 10 weight percent to about 50 weight percent in the polymer. VLMIs are copolymers of an α-olefin, such as ethylene, a softening agent, such as n-butyl-acrylate or iso-butyl-acrylate, and an α, β-unsaturated carboxylic acid, such as acrylic or methacrylic acid, where at least part of the acid groups are neutralized by a magnesium cation. Other examples of softening comonomers include n-butyl methacrylate, methyl acrylate, and methyl methacrylate. Generally, a VLMI has a flexural modulus from about 2,000 psi to about 10,000 psi. VLMIs are sometimes referred to as “soft” ionomers.

Ionomers, such as acid-containing ethylene copolymer ionomers, include E/X/Y copolymers where E is ethylene, X is a softening comonomer such as acrylate or methacrylate present in 0 to 50 weight percent of the polymer, and Y is acrylic or methacrylic acid present in 5 to 35 (often 10 to 20) weight percent of the polymer, wherein the acid moiety is neutralized 1 to 90 percent (usually at least 40 percent) to form an ionomer by a cation such as lithium, sodium, potassium, magnesium, calcium, barium, lead, tin, zinc or aluminum, or a combination of such cations, lithium, sodium and zinc being the most preferred. Specific acid-containing ethylene copolymers include ethylene/acrylic acid, ethylene/methacrylic acid, ethylene/acrylic acid/n-butyl acrylate, ethylene/methacrylic acid/n-butyl acrylate, ethylene/methacrylic acid/iso-butyl acrylate, ethylene/acrylic acid/iso-butyl acrylate, ethylene/methacrylic acid/n-butyl methacrylate, ethylene/acrylic acid/methyl methacrylate, ethylene/acrylic acid/methyl acrylate, ethylene/methacrylic acid/methyl acrylate, ethylene/methacrylic acid/methyl methacrylate, and ethylene/acrylic acid/n-butyl methacrylate.

To aid in the processing of the cover stock, ionomer resins may be blended in order to obtain a cover having desired characteristics. For this reason, the cover may be formed from a blend of two or more ionomer resins. The blend may include, for example, a very soft material and a harder material. Ionomer resins with different melt flow indexes are often employed to obtain the desired characteristics of the cover stock. SURLYN® 8118, 7930 and 7940 have melt flow indices of about 1.4, 1.8, and 2.6 g/10 min., respectively. SURLYN® 8269 and SURLYN® 8265 each have a melt flow index of about 0.9 g/10 min. A blend of ionomer resins may be used to form a cover having a melt flow index, for example, of from about 1 to about 3 g/10 min. The cover layer may have a Shore D hardness, for example, ranging from about 45 to about 80.

The cover also may include thermoplastic and/or thermoset materials. For example, the cover may include a thermoplastic material such as urethane or polyurethane. Polyurethane is a product of a reaction between a polyurethane prepolymer and a curing agent. The polyurethane prepolymer is a product formed by a reaction between a polyol and a diisocyanate. Often, a catalyst is employed to promote the reaction between the curing agent and the polyurethane prepolymer. In the case of cast polyurethanes, the curing agent is typically either a diamine or glycol.

As another example, a thermoset cast polyurethane may be used. Thermoset cast polyurethanes are generally prepared using a diisocyanate, such as 2,4-toluene diisocyanate (TDI), methylenebis-(4-cyclohexyl isocyanate) (HMDI), or para-phenylene diisocyanate (“PPDI”) and a polyol which is cured with a polyamine, such as methylenedianiline (MDA), or a trifunctional glycol, such as trimethylol propane, or tetrafunctional glycol, such as N,N,N′,N′-tetrakis(2-hydroxpropyl)ethylenediamine. Other suitable thermoset materials include, but are not limited to, thermoset urethane ionomers and thermoset urethane epoxies. Other examples of thermoset materials include polybutadiene, natural rubber, polyisoprene, styrene-butadiene, and styrene-propylene-diene rubber.

When the cover includes more than one layer, e.g., an inner cover layer and an outer cover layer, various constructions and materials are suitable. For example, an inner cover layer may surround the intermediate layer with an outer cover layer disposed thereon or an inner cover layer may surround a plurality of intermediate layers. When using an inner and outer cover layer construction, the outer cover layer material may be a thermoset material that includes at least one of a castable reactive liquid material and reaction products thereof, as described above, and may have a hardness from about 30 Shore D to about 60 Shore D.

The inner cover layer may be formed from a wide variety of hard (e.g., about 50 Shore D or greater), high flexural modulus resilient materials, which are compatible with the other materials used in the adjacent layers of the golf ball. The inner cover layer material may have a flexural modulus of about 65,000 psi or greater. Suitable inner cover layer materials include the hard, high flexural modulus ionomer resins and blends thereof, which may be obtained by providing a cross metallic bond to polymers of monoolefin with at least one member selected from the group consisting of unsaturated mono- or di-carboxylic acids having 3 to 12 carbon atoms and esters thereof (the polymer contains 1 to 50 percent by weight of the unsaturated mono- or di-carboxylic acid and/or ester thereof). More particularly, such acid-containing ethylene copolymer ionomer component includes E/X/Y copolymers where E is ethylene, X is a softening comonomer such as acrylate or methacrylate present in 0-50 weight percent of the polymer, and Y is acrylic or methacrylic acid present in 5-35 weight percent of the polymer, wherein the acid moiety is neutralized about 1-90 percent to form an ionomer by a cation such as lithium, sodium, potassium, magnesium, calcium, barium, lead, tin, zinc, or aluminum, or a combination of such cations. Specific examples of acid-containing ethylene copolymers include ethylene/acrylic acid, ethylene/methacrylic acid, ethylene/acrylic acid/n-butyl acrylate, ethylene/methacrylic acid/n-butyl acrylate, ethylene/methacrylic acid/iso-butyl acrylate, ethylene/acrylic acid/iso-butyl acrylate, ethylene/methacrylic acid/n-butyl methacrylate, ethylene/acrylic acid/methyl methacrylate, ethylene/acrylic acid/methyl acrylate, ethylene/methacrylic acid/methyl acrylate, ethylene/methacrylic acid/methyl methacrylate, and ethylene/acrylic acid/n-butyl methacrylate.

Examples of other suitable inner cover materials include thermoplastic or thermoset polyurethanes, polyetheresters, polyetheramides, or polyesters, dynamically vulcanized elastomers, functionalized styrene-butadiene elastomers, metallocene polymers, polyamides such as nylons, acrylonitrile butadiene-styrene copolymers (ABS), or blends thereof.

### Manufacturing Process

While golf balls in accordance with examples of this invention may be made in any desired manner without departing from this invention, including in conventional manners as are known and used in the art, one common technique for manufacturing golf balls is a laminate process. In order to form multiple layers around the center, a laminate is first formed. The laminate includes at least two layers and sometimes includes three layers. The laminate may be formed by mixing uncured core material to be used for each layer and calendar rolling the material into thin sheets. Alternatively, the laminate may be formed by mixing uncured intermediate layer material and rolling the material into sheets. The laminate sheets may be stacked together to form a laminate having three layers, using calender rolling mills. Alternatively, the sheets may be formed by extrusion.

A laminate also may be formed using an adhesive between each layer of material. For example, an epoxy resin may be used as adhesive. The adhesive should have good shear and tensile strength, for example, a tensile strength over about 1500 psi. The adhesive often has a Shore D hardness of less than about 60 when cured. The adhesive layer applied to the sheets should be very thin, e.g., less than about 0.004 inches thick.

Preferably, each laminate sheet is formed to a thickness that is slightly larger than the thickness of the layers in the finished golf ball. Each of these thicknesses can be varied, but all have a thickness of preferably less than about 0.1 inches. The sheets should have very uniform thicknesses.

The next step in the method is to form multiple layers around the center. This may be accomplished by placing two laminates between a top mold and a bottom mold. The laminates may be formed to the cavities in the mold halves. The laminates then may be cut into patterns that, when joined, form a laminated layer around the center. For example, the laminates may be cut into figure 8-shaped or barbell-like patterns, similar to a baseball or a tennis ball cover. Other patterns may be used, such as curved triangles, hemispherical cups, ovals, or other patterns that may be joined together to form a laminated layer around the center. The patterns may then be placed between molds and formed to the cavities in the mold halves. A vacuum source often is used to form the laminates to the mold cavities so that uniformity in layer thickness is maintained.

After the laminates have been formed to the cavities, the centers are then inserted between the laminates. The laminates are then compression molded about the center under conditions of temperature and pressure that are well known in the art. The mold halves usually have vents to allow flowing of excess layer material from the laminates during the compression molding process. As an alternative to compression molding, the core and/or intermediate layer(s) may be formed by injection molding or other suitable technique.

The next step involves forming a cover around the golf ball core. The core, including the center and any intermediate layers, may be supported within a pair of cover mold-halves by a plurality of retractable pins. The retractable pins may be actuated by conventional means known to those of ordinary skill in the art.

After the mold halves are closed together with the pins supporting the core, the cover material is injected into the mold in a liquid state through a plurality of injection ports or gates, such as edge gates or sub-gates. With edge gates, the resultant golf balls are all interconnected and may be removed from the mold halves together in a large matrix. Sub-gating automatically separates the mold runner from the golf balls during the ejection of the golf balls from mold halves.

The retractable pins may be retracted after a predetermined amount of cover material has been injected into the mold halves to substantially surround the core. The liquid cover material is allowed to flow and substantially fill the cavity between the core and the mold halves, while maintaining concentricity between the core and the mold halves. The cover material is then allowed to solidify around the core, and the golf balls are ejected from the mold halves and subjected to finishing processes, including coating, painting, and/or other finishing processes, including processes in accordance with examples of this invention, as will be described in more detail below.

### B. General Description of Coating Materials

The coating comprises a resin and a plurality of particles. The resin may be any suitable resin, non-limiting examples of which include thermoplastics, thermoplastic elastomers, such as polyurethanes, polyesters, acrylics, low acid thermoplastic ionomers, e.g., containing up to about 15% acid, and UV curable systems.

The coating may comprise additional additives incorporated into the resin, such as flow additives, mar/slip additives, adhesion promoters, thickeners, gloss reducers, flexibilizers, cross-linking additives, isocyanates or other agents for toughening or creating scratch resistance, optical brighteners, UV absorbers, and the like. The amount of such additives usually ranges from 0 to about 5 wt %, often from 0 to about 1.5 wt %, based on total weight of the coating.

In addition, solid particles may be contained within the resin or adhered to and/or embedded into the surface of resin as described in more detail below.

### C. General Description of Coating Devices

The coating materials may be delivered by spray guns (either fixed or articulating types). Examples of devices that may be used include heated spray equipment and electrostatic and high volume-low pressure (HVLP) devices. The golf balls are typically placed on work holders, where they rotate and pass through a spray zone in a specified time to obtain full coverage of their exterior surfaces. Additionally or alternatively, if desired, the spray heads that apply the coating material may be movable with respect to the balls and/or articulated to assist in applying a uniform coating to the entire ball structure. Suitable coating systems and methods for use in this invention may include conventional coating systems as are known and used in the art.

In some aspects of this invention, a carrier fluid comprising nitrogen gas or nitrogen-enriched air may be used to deliver the coating material to the exterior surface of the golf ball. Nitrogen is clean, dry (anhydrous) in its elemental gas state. Nitrogen can be ionized to eliminate problems associated with moisture and static electricity.

Suitable equipment for applying coatings using nitrogen-enriched air is described, for example, in U.S. Pat. No. 6,821,315, the disclosure of which is incorporated by reference in its entirety. Such devices are commercially available from N2 Spray Solutions. In general, such devices operate by mixing a carrier fluid under pressure and the coating material. The carrier fluid comprises nitrogen-enriched air, which typically contains about 90-99.5% nitrogen by volume. Nitrogen-enriched air may be produced, for example, by passing air through hollow-fiber membranes as described in the '315 patent.

The temperature of the carrier fluid may be adjusted to optimize coating properties. In general, heating the carrier fluid reduces viscosity and reduces the need for solvents. Reducing viscosity improves flow, aides in atomization, and purges the solvent, resulting in a finer spray with a higher solids content. The carrier fluid may be heated, for example, to a temperature of about 100 to about 170° F. (38 to 76.6° C.), often from about 150 to about 170° F. (65.6 to 76.6° C.). Other parameters, such as pressure, also may be suitably adjusted to achieve improved drying characteristics and/or other efficiencies. For example, atomization air pressure of about 40 psi (275.8 kPa) may be employed. U.S. patent application Ser. No. 12/470,820 filed May 22, 2009 and entitled “Method of Applying Topcoat to Exterior Surface of Golf Ball” describes systems and methods utilizing nitrogen-containing or nitrogen-enriched delivery fluids to apply coating materials to golf balls. This patent application is entirely incorporated herein by reference.

### D. Specific Examples of Invention

The term “golf ball body” means a golf ball before applying the top coat (e.g., core, intermediate layers, cover layer with dimples). In terms of the discussion below, the term “coating” often will be used to identify the top coat or last layer applied to the golf ball, but, as also described below, if desired, another coating may be applied over the roughened coating material, if desired, provided that an overall roughened surface is still provided. Often the terms “paint” or “painting” are used synonymously with a “coating” or “coating” process.

Aspects of this invention relate to golf balls having a top coat or other coating over the cover layer, wherein this coating comprises a resin having particles contained therein or applied thereon. The particles provide a golf ball surface having a slightly roughened surface, as will be described in more detail below.

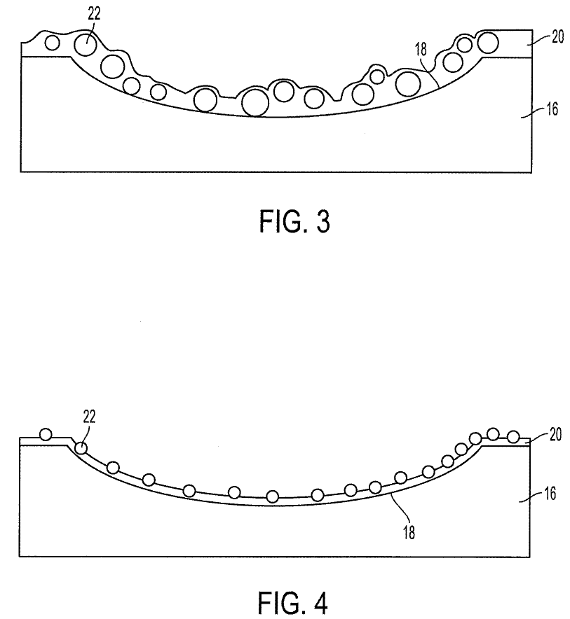

If the resin contains the particles, after the resin is applied to the golf ball body to form the coating, the particles may protrude beyond an average thickness of the resin. In some instances, the average size of the particles may be greater than the average thickness of the resin. As shown in FIG. 3, generally the particles 22 protrude from the surface such that a thin portion of the resin 20 still covers the particles. The surface of the ball will therefore be roughened somewhat, as shown in FIG. 3.

If the resin itself does not contain the particles necessary to provide the roughened surface when it is applied to the golf ball cover 18, after the resin is applied, and prior to drying, particles may be applied to the wet resin. The particles may adhere to and/or become embedded into the resin, but still extend from the surface of the resin to provide a somewhat roughened surface. As shown in FIG. 4, in this example structure and method, particles 22 are applied to the surface of resin 20.

The particles allow for fine tuning of and improvement on the aerodynamic performance of golf balls in flight, e.g., to enable longer flights of the golf ball. The particles cause the finish of the coating to be rougher and on a micro-scale act as small dimples, which increase the turbulence in the air flow around the ball and reduce flow separation on the golf ball, reducing pressure drag. Also, if desired, the durability of the golf ball may be improved both in cut resistance and abrasion resistance, e.g., depending on the properties of and/or materials used in the coating.

Given the general description of various example aspects of the invention provided above, more detailed descriptions of various specific examples of golf ball structures according to the invention are provided below.

### II. DETAILED DESCRIPTION OF EXAMPLE GOLF BALLS, AND METHODS ACCORDING TO ASPECTS OF THE INVENTION

The following discussion and accompanying figures describe various example golf balls in accordance with aspects of the present invention. When the same reference number appears in more than one drawing, that reference number is used consistently in this specification and the drawings to refer to the same or similar parts throughout.

FIG. 3 and FIG. 4 demonstrate aspects of the invention related to golf balls having a top coat or other coating comprising resin and particles contained within the resin or applied and/or embedded thereon, respectively.

The particles may be of any shape and may be regular, irregular, uniform, non-uniform, or mixtures thereof. The particles may be any polygon or geometric shape, including regular shapes, such as spheres or cubes. The spheres may have a round cross-section or may be flattened to provide an elongated or oval cross-section. The cubes may be of square or rectangular cross-section. Irregular shapes may be defined by an irregular surface, an irregular perimeter, protrusions, or extensions. The particles may be rounded, elongated, smooth, rough, or have edges. Combinations of different shapes of particles may be used. Crystalline or regular particles such as tetrapods may also be used.

Particles may be made from any material known in the art, such as organic or inorganic, plastics, composite materials, and metals. Suitable particles include, but are not limited to amorphous particles such as silicas and crystalline particles such as metal oxides, e.g., zinc oxide, iron oxides, or titanium oxide. As additional examples, particles may comprise fumed silica, amorphous silica, colloidal silica, alumina, colloidal alumina, titanium oxide, cesium oxide, yttrium oxide, colloidal yttria, zirconia, colloidal zirconia, polyethylene terephthalate, polybutylene terephthalate, polyethylene naphthalate, vinyl esters, epoxy materials, phenolics, aminoplasts, polyurethanes and composite particles of silicon carbide or aluminum nitride coated with silica or carbonate.

The particles may be selected to fine-tune the roughness of the golf ball to achieve the desired aerodynamic qualities of the golf ball as well as to improve abrasion resistance. The particles may by of any suitable hardness and durability. Softer particles tend to affect spin, for example.

The average size of the particles depends on the material selected for the particles. Generally, the particle sizes will range from 400 nm to 40 microns, and in some example constructions, from 5 to 20 microns. In one particular example, the particle sizes range from 8 to 12 microns. The particles may be approximately the same size or may be different sizes within the defined ranges. If the particles are applied to the surface of the resin, they would generally be smaller than if they were contained within the coating.

Any suitable resin may be used including thermoplastics, thermoplastic elastomers such as polyurethanes, polyesters, acrylics, low acid thermoplastic ionomers, e.g., containing up to about 15% acid, and UV curable systems. Specific examples include AKZO NOBEL 7000A103.

Additional additives optionally may be incorporated into the resin, such as flow additives, mar/slip additives, adhesion promoters, thickeners, gloss reducers, flexibilizers, cross-linking additives, isocyanates or other agents for toughening or creating scratch resistance, optical brighteners, UV absorbers, and the like. The amount of such additives usually ranges from 0 to about 5 wt %, often from 0 to about 1.5 wt %.

The viscosity of the resin prior to application to the golf ball body is generally 16 to 24 seconds as measured by #2 Zahn cup. Generally the resin is thin enough to easily spray the coating onto the golf ball body, but thick enough to prevent the resin from substantially running after application to the golf ball body.

The thickness of the applied resin (after drying) typically ranges from of about 8 to about 50 μm, and in some examples, from about 10 to about 15 μm. When the particles are contained within the resin, the thickness of the resin may be less than the particle size in order to allow the particles to protrude from the resin.

The coating contains a plurality of particles, generally, 0.1 to 30 wt % particles based on total coating weight, for example, 3 to 10 wt %.

The coating may be clear or opaque and may be white or have a tint or hue. The particles may be of any color. Generally application of the coating and particles to the outside of the golf ball will give the ball somewhat of a dull or matte finish, as compared to the brighter or shinier finish of many conventional golf balls. The particles tend to diffuse some of the light in a clear coat for example.

According to the one aspect of the present invention, a coating is formed by applying and drying a resin on the surface of the golf ball body. The method of applying the resin is not limited. For example, a two-component curing type resin such as a polyurethane may be applied by an electrostatic coating method, or spray method using a spray gun, for example after mixing an aqueous polyol liquid with a polyisocyanate. In the case of applying the coating with the spray gun, the aqueous polyol liquid and the polyisocyanate may be mixed bit by bit, or the aqueous polyol liquid and the polyisocyanate are fed with the respective pumps and continuously mixed in a constant ratio through the static mixer located in the stream line just before the spray gun. Alternatively, the aqueous polyol liquid and the polyisocyanate can be air-sprayed respectively with the spray gun having the device for controlling the mixing ratio thereof. Subsequently, the two-component curing type urethane resin on the surface of the golf ball body is dried.

In one aspect the coating comprises resin (with any additives) and particles mixed therein. The coating is applied to the golf ball body such as described above. Prior to application to the golf ball body, the particles may be added to the resin as a separate ingredient, or may be pre-mixed with one of the components in a two-component coating composition.

In another aspect, a resin layer (with any additives) is applied to the golf ball body such as described above. Prior to drying, particles are applied to the top of the wet resin layer using a media blaster, sand blaster, powder coating device, or other suitable device. The particles may adhere to the surface and/or be embedded into the surface of the resin layer.

In another aspect, a very thin resin layer may be applied on top of the particles to hold the particles in place. Generally this resin layer is composed of the same resin layer initially applied, but may have a thinner viscosity. This additional thin layer of resin may be provided, if necessary or desired, to fine tune or somewhat reduce the exterior surface roughness of the ball.

### Examples

Golf balls were prepared with the following coatings and then tested for various properties
Inventive #1—Polyurethane Clear Coat with small silica particles (1 um to 500 nm). Smooth appearance.
Inventive #2—Polyurethane Clear Coat with large silica particles (1 um to 5 um). Rough, matte appearance.
Comparative—Standard Polyurethane Clear Coat with no particles.

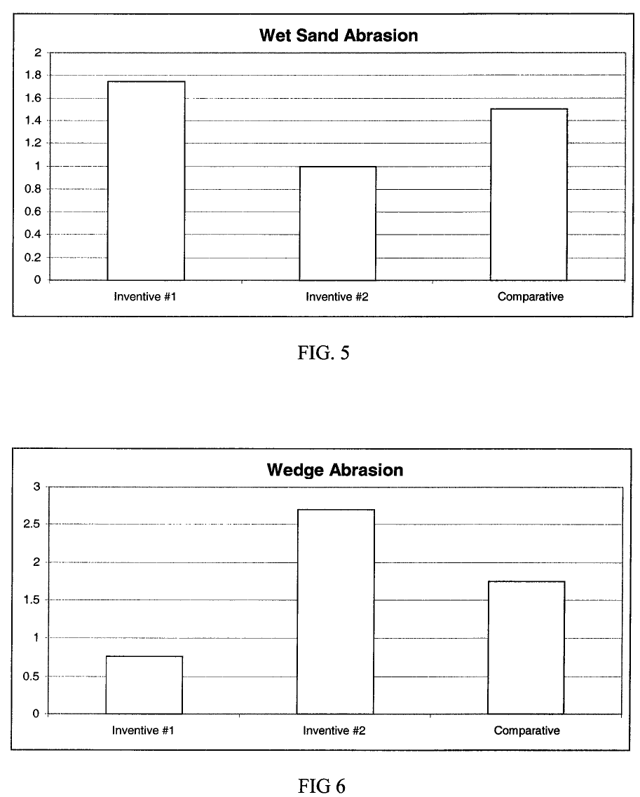

In the Wet Sand Abrasion test, balls were tumbled in wet sand for 8 hrs. The balls were compared visually. Lower scores indicated less damage to the ball. The balls were graded from 1 to 5 with 1 being the best and 5 being the worst. Attention is drawn to FIG. 5.

In the Wedge Abrasion test, balls were hit with a standard 56 deg. wedge and the degree of scuffing was visually analyzed. Lower scores again indicated less damage to the ball. The balls were graded from 1 to 5 with 1 being the best and 5 being the worst. Attention is drawn to FIG. 6.

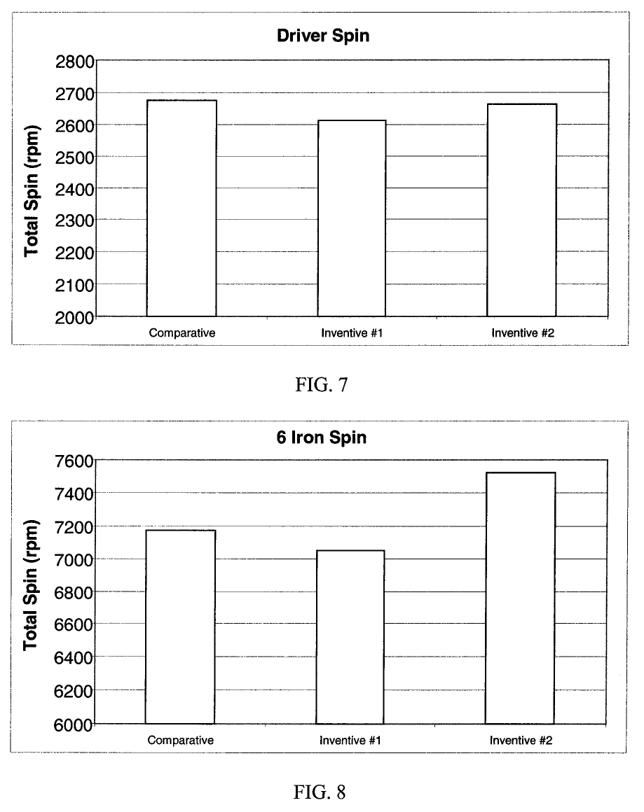

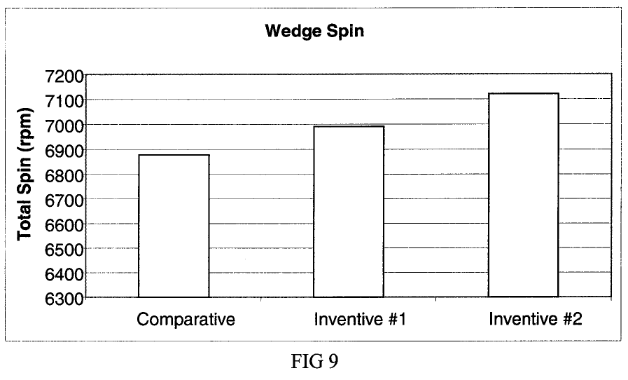

The spin graphs (FIGS. 7-9) show the inventive coating can increase spin off of irons and wedges without increasing driver spin. This is advantageous for more distance off the drive (lower spin) and more control around the green (higher spin).

The golf ball body of the present invention has no limitation on its structure and includes a one-piece golf ball, a two-piece golf ball, a multi-piece golf ball comprising at least three layers, and a wound-core golf ball. The present invention can be applied for all types of the golf ball.

### III. CONCLUSION

The present invention is described above and in the accompanying drawings with reference to a variety of example structures, features, elements, and combinations of structures, features, and elements. The purpose served by the disclosure, however, is to provide examples of the various features and concepts related to the invention, not to limit the scope of the invention. One skilled in the relevant art will recognize that numerous variations and modifications may be made to the embodiments described above without departing from the scope of the present invention, as defined by the appended claims. For example, the various features and concepts described above in conjunction with the figures may be used individually and/or in any combination or subcombination without departing from this invention.

We claim:

1. A golf ball, comprising:
a golf ball body having an outer surface including a plurality of dimples formed therein; and
a coating applied to the outer surface of the golf ball body;
the coating comprising a resin and a plurality of particles, wherein the particles have an average size of 400 nm to 40 microns.

2. The golf ball according to claim 1 wherein the particles have an average size of 5 to 20 microns

3. The golf ball according to claim 1 wherein the resin has an average thickness of 8 to 50 microns.

4. The golf ball according to claim 1 wherein the resin has an average thickness of 10 to 15 microns.

5. The golf ball of claim 1 wherein the resin includes a thermoplastic elastomer.

6. The golf ball of claim 5 wherein the thermoplastic elastomer is selected from the group consisting of polyurethanes, polyesters, acrylics, and low acid thermoplastic ionomers containing up to about 15% acid.

7. The golf ball of claim 1 wherein the resin is UV curable.

8. The golf ball of claim 1 wherein the coating further comprises up to about 5 wt % of at least one component selected from the group consisting of: flow additives, mar/slip additives, adhesion promoters, thickeners, gloss reducers, flexibilizers, cross-linking additives, isocyanates, optical brighteners, and UV absorbers, based on a total weight of the coating.

9. The golf ball of claim 1 wherein the particles comprise 1 to 30 wt % of the total weight of the coating.

10. The golf ball of claim 1 wherein the particles are selected from the group consisting of: fumed silica, amorphous silica, colloidal silica, alumina, colloidal alumina, titanium oxide, cesium oxide, yttrium oxide, colloidal yttria, zirconia, colloidal zirconia, polyethylene terephthalate, polybutylene terephthalate, polyethylene naphthalate, vinyl esters, epoxy materials, phenolics, aminoplasts, polyurethanes and composite particles of silicon carbide or aluminum nitride coated with silica or carbonate.

11. The golf ball according to claim 1 wherein the coating comprises particles contained within the resin.

12. The golf ball according to claim 1 wherein the coating comprises a resin layer applied to the outer surface of the golf ball body and a plurality of particles adhered to or embedded in an outer surface of the resin layer.

13. The golf ball according to claim 1 wherein the golf ball body comprises a core and a cover layer, wherein the plurality of dimples are formed in the cover layer.

14. A method of forming a coating on an outer surface of a golf ball body comprising:
a) combining a resin and a plurality of particles;
b) applying the combination of resin and particles to the outer surface of the golf ball body, wherein the outer surface of the golf ball body includes a plurality of dimples formed therein;
wherein the particles have an average particle size of 400 nm to 40 microns.

15. The method of claim 14 wherein the combination of resin and particles is applied by spraying.

16. The method according to claim 14 wherein the particles have an average size of 5 to 20 microns

17. The method according to claim 14 further wherein the resin applied to the golf ball body has an average thickness of 8 to 50 microns.

18. The method according to claim 14 wherein the resin applied to the golf ball body has an average thickness of 10 to 15 microns.

19. A method of forming a coating on an outer surface of a golf ball body comprising:
a) applying a resin layer to the outer surface of the golf ball body, wherein the outer surface of the golf ball body includes a plurality of dimples formed therein;
b) applying a plurality of particles to an exterior surface of the resin layer, wherein the particles are adhered to or embedded into the surface of the resin layer;
wherein the particles have an average particle size of 400 nm to 40 microns.

20. The method of claim 19 wherein the combination of resin and particles is applied by spraying.

21. The method according to claim 19 wherein the particles have an average size of 5 to 20 microns.

22. The method according to claim 19 further wherein the resin applied to the golf ball body has an average thickness of 8 to 50 microns.

23. The method according to claim 19 wherein the resin applied to the golf ball body has an average thickness of 10 to 15 microns.
